(19) United States
(12) Patent Application Publication
(10) Pub. No.: US 2025/0264647 A1
(43) Pub. Date: Aug. 21, 2025

(54) OPTICAL DEVICE, OPTICAL FILTER

(71) Applicant: Asahi Kasei Microdevices Corporation, Tokyo (JP)

(72) Inventor: Kengo SASAYAMA, Tokyo (JP)

(73) Assignee: Asahi Kasei Microdevices Corporation, Tokyo (JP)

(21) Appl. No.: 19/048,968

(22) Filed: Feb. 10, 2025

(30) Foreign Application Priority Data
Feb. 15, 2024 (JP) 2024-021545
Jan. 10, 2025 (JP) 2025-004272

(51) Int. Cl. G02B 5/28

(52) U.S. Cl. CPC G02B 5/281

(57) ABSTRACT

An optical device and an optical filter that enable compact and high precision concentration measurement are provided. The optical device includes an optical filter and an infrared optical element. When the center wavelength of a transmission band is λp, then in a wavelength range from (λp×0.6) nm to (λp×0.8) nm, when the angle of incidence at which infrared light emitted from or incident on the infrared optical element is incident on the optical filter is 0°, the maximum transmittance of the optical filter is T1 and the average sensitivity of the infrared optical element is S1, and when 45°, the maximum transmittance of the optical filter is T2 and the average sensitivity of the infrared optical element is S2, then T2 is greater than T1 and S2 is smaller than S1.

### CROSS-REFERENCE TO RELATED APPLICATION

The present application claims priority to and the benefit of Japanese Patent Application No. 2024-021545 filed Feb. 15, 2024, and Japanese Patent Application No. 2025-004272 filed Jan. 10, 2025, the entire contents of which are incorporated herein by reference.

### TECHNICAL FIELD

The present disclosure relates to an optical device and an optical filter.

### BACKGROUND

Non-dispersive infrared (NDIR) absorption gas concentration measuring devices are known as conventional gas concentration measuring devices that measure concentration of a gas to be measured in the atmosphere. Different kinds of gas absorb infrared light at different wavelengths, and a non-dispersive infrared absorption gas concentration measuring device utilizes this principle and measures gas concentration by detecting the amount of absorption. A non-dispersive infrared absorption gas concentration measuring device comprises an infrared optical element and a filter (transmission member) that transmits infrared light limited to a wavelength at which a gas to be measured has absorption properties. For example, Patent Literature (PTL) 1 describes a measuring device for which the gas to be measured is carbon dioxide gas.

### CITATION LIST

### Patent Literature

PTL 1: JP H09-33431 A

### SUMMARY

### Technical Problem

The gas to be measured is not limited to carbon dioxide gas, and may be any of various gases. An optimal combination of infrared optical element and optical filter for each gas to be detected has not yet been studied. In particular, optical filter specifications, including the effect of angle of incidence, have not yet been optimized.

In view of such circumstances, it would be helpful to provide an optical device and an optical filter that enable compact and high precision concentration measurement. Here, the optical device includes an infrared optical element and an optical filter, and is a device used in a gas concentration measuring device or the like.

### Solution to Problem

(1) An optical device according to an embodiment of the present disclosure comprises:
an optical filter including a substrate and a multilayer film formed on at least one surface of the substrate, the multilayer film including a plurality of layers having different refractive indices; and
an infrared optical element that emits or receives infrared light, wherein
the optical filter has, in a wavelength range from 2500 nm to 10,000 nm, a transmission band of 50 nm or more with a transmittance of more than 70%, wherein the center wavelength of the transmission band is λp, a maximum transmittance in a wavelength range from (λp×0.6) nm to (λp×0.8) nm is 2% or more, and the maximum transmittance is at least twice as large as a minimum transmittance in a wavelength range from (λp×0.8) nm to (λp×0.9) nm,
the infrared optical element has a peak sensitivity that is a maximum sensitivity, and an average sensitivity in the wavelength range from (λp×0.6) nm to (λp×0.8) nm is 70% or less of the peak sensitivity, and
in the wavelength range from (λp×0.6) nm to (λp×0.8) nm, when the angle of incidence at which infrared light emitted from or incident on the infrared optical element is incident on the optical filter is 0°, the maximum transmittance of the optical filter is T1 and the average sensitivity of the infrared optical element is S1, and when the angle of incidence at which infrared light emitted from or incident on the infrared optical element is incident on the optical filter is 45°, the maximum transmittance of the optical filter is T2 and the average sensitivity of the infrared optical element is S2, then T2 is greater than T1 and S2 is smaller than S1.

(2) The optical device according to (1), as an embodiment of the present disclosure, wherein
the transmittance of the optical filter at λp, the center wavelength of the transmission band, is at least 1.1 times the maximum transmittance in the wavelength range from (λp×0.6) nm to (λp×0.8) nm.

(3) The optical device according to (1) or (2), as an embodiment of the present disclosure, wherein
the optical filter has a maximum transmittance of 2% or more in a wavelength range from (λp×0.4) nm to (λp×0.6) nm.

(4) The optical device according to any one of (1) to (3), as an embodiment of the present disclosure, wherein
the optical filter has a maximum transmittance of 60% or less and an average transmittance of 40% or less in the wavelength range from (λp×0.6) nm to (λp×0.8) nm.

(5) The optical device according to any one of (1) to (4), as an embodiment of the present disclosure, wherein
the optical filter is a bandpass filter with a full width at half maximum of 1000 nm or less.

(6) The optical device according to any one of (1) to (5), as an embodiment of the present disclosure, wherein
the infrared optical element is an infrared light-emitting element that emits infrared light, and the average sensitivity in the wavelength range from (λp×0.6) nm to (λp×0.8) nm is 30% or less of the peak sensitivity.

(7) The optical device according to any one of (1) to (6), as an embodiment of the present disclosure, wherein
total film thickness of the multilayer film is 30 μm or less.

(8) An optical device according to an embodiment of the present disclosure comprises:
an optical filter including a substrate and a multilayer film formed on at least one surface of the substrate, the multilayer film including a plurality of layers having different refractive indices; and
an infrared optical element that emits or receives infrared light, wherein
the optical filter has, in a wavelength range from 2500 nm to 10,000 nm, a transmission band of 50 nm or more with a transmittance of more than 70%, wherein the center wavelength of the transmission band is λp, a maximum transmittance in a wavelength range from (λp×0.6) nm to (λp×0.8) nm is at least twice as large as a minimum transmittance in a wavelength range from (λp×0.8) nm to (λp×0.9) nm, and a maximum transmittance in a wavelength range from (λp×0.4) nm to (λp×0.6) nm is 2% or more,
the infrared optical element has a peak sensitivity that is a maximum sensitivity, and an average sensitivity in the wavelength range from (λp×0.6) nm to (λp×0.8) nm is 70% or less of the peak sensitivity, and
in the wavelength range from (λp×0.6) nm to (λp×0.8) nm, when the angle of incidence at which infrared light emitted from or incident on the infrared optical element is incident on the optical filter is 0°, the maximum transmittance of the optical filter is T1 and the average sensitivity of the infrared optical element is S1, and when the angle of incidence at which infrared light emitted from or incident on the infrared optical element is incident on the optical filter is 45°, the maximum transmittance of the optical filter is T2 and the average sensitivity of the infrared optical element is S2, then T2 is greater than T1 and S2 is smaller than S1.

(9) The optical device according to (1) or (2), as an embodiment of the present disclosure, wherein
the infrared optical element includes a first conductivity-type semiconductor layer, an active layer, and a second conductivity-type semiconductor layer.

(10) The optical device according to (1) or (2), as an embodiment of the present disclosure, wherein
the infrared optical element is an infrared light-emitting element.

(11) The optical device according to (1) or (2), as an embodiment of the present disclosure, wherein
T2 is at least 1% greater than T1.

(12) The optical device according to (8), as an embodiment of the present disclosure, wherein
the maximum transmittance in the wavelength range from (λp×0.4) nm to (λp×0.6) nm is 25% or more.

(13) An optical filter according to an embodiment of the present disclosure is
used in the optical device according to (1) or (8).

### Advantageous Effect

According to the present disclosure, an optical device and an optical filter can be provided that enable compact and high precision concentration measurement even in the case of oblique incidence, where the effect of light leakage is large.

### BRIEF DESCRIPTION OF THE DRAWINGS

In the accompanying drawings:

FIG. 1 is a diagram illustrating an example of a cross-section of an optical filter;

FIG. 2 is a diagram illustrating an example of a concentration measuring device including an optical device according to an embodiment of the present disclosure;

FIG. 3 is a diagram for describing a comparison between an optical filter of an optical device according to an embodiment of the present disclosure and an optical filter according to a comparative example;

FIG. 4 is a diagram illustrating a difference between an optical filter according to a comparative example and an optical filter according to the present disclosure;

FIG. 5 is a diagram illustrating a stack structure of layers of infrared optical elements according to Examples 1 to 6;

FIG. 6A is a diagram for comparison of transmittance of an Example and a Comparative Example;

FIG. 6B is a diagram for comparison of transmittance of an Example and a Comparative Example;

FIG. 7 is a diagram comparing sensitivity of an Example and a Comparative Example.

FIG. 8 is a diagram comparing properties of normal incidence (0° angle of incidence) and 45° incidence (45° angle of incidence).

### DETAILED DESCRIPTION

The following describes an optical device and an optical filter according to an embodiment of the present disclosure, with reference to the drawings.

### (Optical Device)

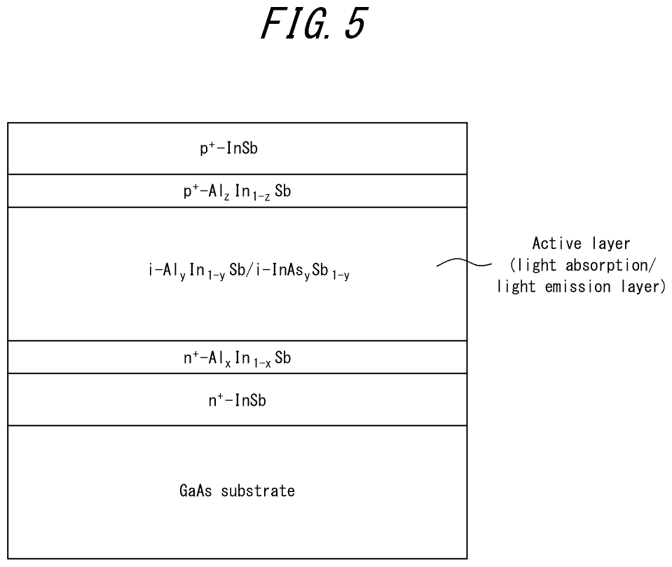

The optical device according to the present embodiment includes an optical filter and an infrared optical element. The optical filter includes a substrate and a multilayer film formed on at least one surface of the substrate, the multilayer film including a plurality of layers having different refractive indices. The infrared optical element is an infrared light-receiving element or an infrared light-emitting element, and is a collective name applied to either element. Further, hereinafter, receive/emit light means having at least one of the functions of light-receiving or light-emitting. The infrared optical element comprises, for example, a first conductivity-type semiconductor layer, an active layer, and a second conductivity-type semiconductor layer, and receives/emits infrared light. That is, the optical device according to the present embodiment is an infrared device. An infrared light-emitting element is realized by a structure described below (see FIG. 5), and an infrared light-receiving element is realized by the same structure. The infrared light-emitting element may specifically be a light emitting diode (LED), an incandescent light bulb, a laser, an organic light emitting section, a VCSEL, a PCSEL, a MEMS heater, or the like. From the viewpoint of wavelength selectivity, the infrared light-emitting element is preferably a light emitting diode (LED). Further, the infrared light-receiving element may be specifically a photodiode (PD), a phototransistor, a thermopile, a current collecting sensor, a bolometer, or the like. From the viewpoint of wavelength selectivity, the infrared light-receiving element is preferably a photodiode (PD).

The following description assumes that the optical device according to the present embodiment is used in a concentration measuring device. According to the present embodiment, the concentration measuring device is a gas sensor that measures concentration of a gas to be measured. The concentration measuring device may be, for example, a non-dispersive infrared (NDIR) absorption gas sensor including a light-receiver that receives infrared light transmitted through gas. Further, the concentration measuring device may be, for example, a photoacoustic gas sensor that measures gas concentration by picking up vibration of gas molecules that have absorbed light as sound using a high-performance microphone. Here, the optical device according to the present embodiment is not limited to use in a concentration measuring device, and may be used in an infrared radiation thermometer, infrared spectroscopic imaging, or a human body detection sensor.

As described below in detail, the optical filter has, in a wavelength range from 2500 nm to 10,000 nm, a transmission band of 50 nm or more with a transmittance of more than 70%. Further, the optical filter, when the center wavelength of the transmission band is λp, has a maximum transmittance in a wavelength range from (λp×0.6) nm to (λp×0.8) nm of 2% or more. Further, the maximum transmittance is at least twice as large as a minimum transmittance in a wavelength range from (λp×0.8) nm to (λp×0.9) nm. Here, the center wavelength is the wavelength at the center of the full width at half maximum of the transmission band having the maximum transmittance in the wavelength range from 2500 nm to 10,000 nm. Further, the full width at half maximum is the width of the wavelength at which transmittance is half of the maximum transmittance (that is, the difference between the maximum wavelength and the minimum wavelength).

As described below in detail, the infrared optical element has a peak sensitivity that is a maximum sensitivity, and an average sensitivity in the wavelength range from (λp×0.6) nm to (λp×0.8) nm that is 70% or less of the peak sensitivity. Here, in the wavelength range from (λp×0.6) nm to (λp×0.8) nm, when the angle of incidence of infrared light emitted from or incident on the infrared optical element and incident on the optical filter is 0°, the maximum transmittance of the optical filter is T1 and the average sensitivity of the infrared optical element is S1. Further, in the wavelength range from (λp×0.6) nm to (λp×0.8) nm, when the angle of incidence of infrared light emitted from or incident on the infrared optical element and incident on the optical filter is 45°, the maximum transmittance of the optical filter is T2 and the average sensitivity of the infrared optical element is S2. T2 is larger than T1 and S2 is smaller than S1.

According to the optical device of the present embodiment, even when a simplified optical filter is used, selectively receiving or emitting only infrared light in a desired wavelength band is possible. By using a simplified optical filter, the optical device according to the present embodiment can be made compact. Further, because receiving/emitting infrared light in a desired wavelength band is possible, the optical device according to the present embodiment enables high precision concentration measurement.

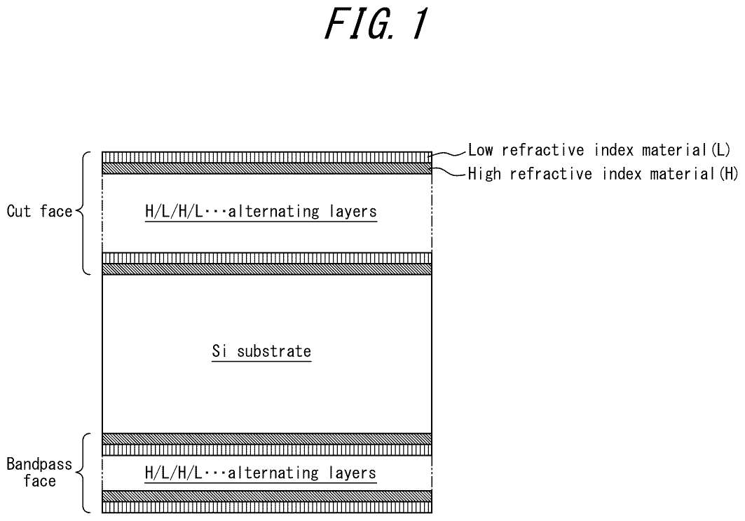

FIG. 1 illustrates an example of a cross-section of the optical filter. According to the present embodiment, the optical filter includes alternating layers of low refractive index material (L) made of SiO, SiO₂, TiO₂, ZnS, or Al₂O₃, or the like, and high refractive index material (H) made of Si, Ge, or the like, on both sides of a Si substrate. As the low refractive index material (L), a material having a refractive index from 1.2 to 2.5 is preferably selected. As the high refractive index material (H), a material having a refractive index that is at least 0.5 more than that of the low refractive index material (L) is preferably selected. The multilayer films of alternating layers are each formed so that the layer directly on the Si substrate is the high refractive index material (H). However, the optical filter is not limited to the configuration illustrated in FIG. 1. For example, the high refractive index material (H) need not be directly on the substrate.

According to the present embodiment, the optical filter is an interference bandpass filter in the mid-infrared range. Typically, interference bandpass filters in the mid-infrared range have a large number of layers and are prone to increased defects during film formation. Further, when the number of layers in the optical filter is large, downsizing a concentration measuring device is difficult. Therefore, the number of layers in the optical filter is preferably small. However, when the number of layers in the optical filter is simply reduced and simplified, the precision of the gas sensor may degrade.

Further, in order to realize a high precision concentration measuring device, decreasing the effect on infrared absorption by gases other than the gas to be detected is necessary.

Further, in order to realize a high precision concentration measuring device, decreasing the effect of light leakage when infrared light is incident on the optical filter from an oblique angle is necessary.

As a result of studying optimal combinations of infrared optical elements and optical filters, the inventor has realized an optical device where precision does not degrade even using a simplified optical filter, as described below.

Here, a simplified optical filter is an optical filter that does not cut a range where a sensor has no sensitivity, and therefore does not include layers of optical thin film required to cut the range. The use of a simplified optical filter with fewer layers is expected to improve mass productivity. Further, by reducing the number of layers, defects during film formation can be decreased, and as a result, yield improvement can be expected. Further, a decrease in warpage caused by multilayer stacking suppresses occurrence of chipping during dicing and improves mass production stability.

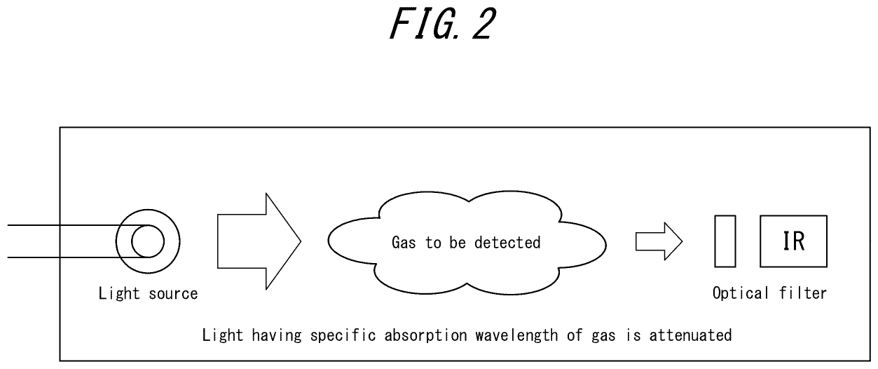

FIG. 2 is a diagram illustrating an example of a concentration measuring device using the optical device according to the present embodiment. In the optical device according to the present embodiment, as illustrated in FIG. 2, an infrared light-receiving element (IR) is disposed in the optical path of infrared light to be output from an infrared light-emitting element (light source), and an optical filter that selectively transmits the absorption wavelength of a gas to be detected is disposed in front of the infrared light-receiving element. The optical device corresponds, for example, to the optical filter and the infrared light-receiving element.

Here, the gas to be measured by the concentration measuring device may be, but is not limited to, carbon dioxide. For example, the gas to be measured may be a combustible gas such as breath alcohol (ethanol, etc.), methane, propane, hydrogen, ethylene, MCH (methylcyclohexane), etc. The gas to be measured may also be a toxic gas such as carbon monoxide, hydrogen sulfide, formaldehyde, ammonia, etc. Furthermore, the gas to be measured may be a greenhouse gas such as dinitrogen monoxide or a refrigerant gas used in an air conditioner or refrigerator. In addition, the gas to be measured may be a mixed gas in which the above-mentioned gases to be measured are mixed.

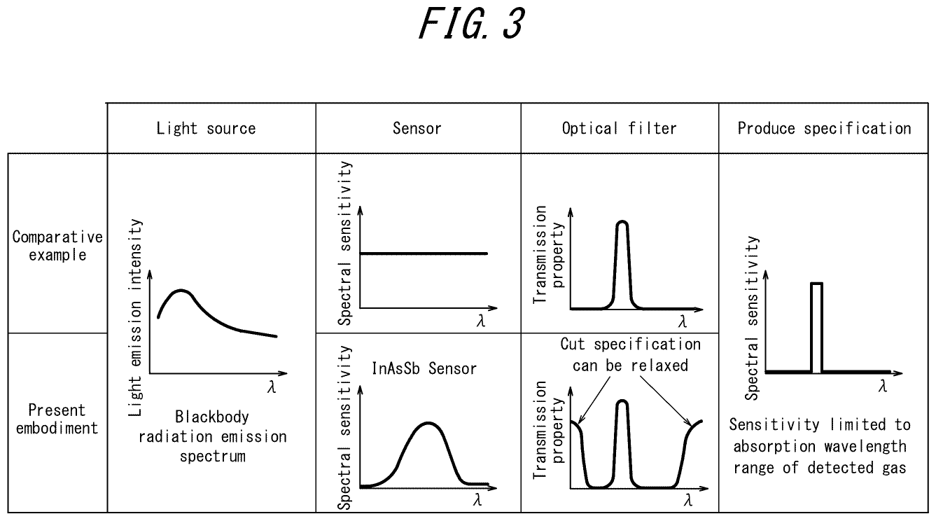

FIG. 3 is a diagram for describing a comparison between the optical filter of the optical device according to the present embodiment and an optical filter according to a comparative example. The sensor (infrared light-receiving element) of the comparative example has no wavelength selectivity in spectral sensitivity (sensitivity does not change based on wavelength). In contrast, the sensor included in the optical device (or included in the concentration measuring device using the optical device) according to the present embodiment has wavelength selectivity. Therefore, according to the present embodiment, there is no need for the optical filter to cut wavelengths for which there is no sensitivity, and the optical filter can be simplified. Similarly, in the case of an infrared light-emitting element that has wavelength selectivity in emission intensity, there is no need for the optical filter to cut wavelengths that are not emitted, and the optical filter can be simplified. Here, in FIG. 3, the wavelengths for which there is no sensitivity and the wavelengths that are not emitted are illustrated both on the wavelength side longer than the peak wavelength (high wavelength side) and on the wavelength side shorter than the peak wavelength (short wavelength side), but this is only a conceptual example. According to the present embodiment, the wavelength cut specification of the optical filter is relaxed on the short wavelength side.

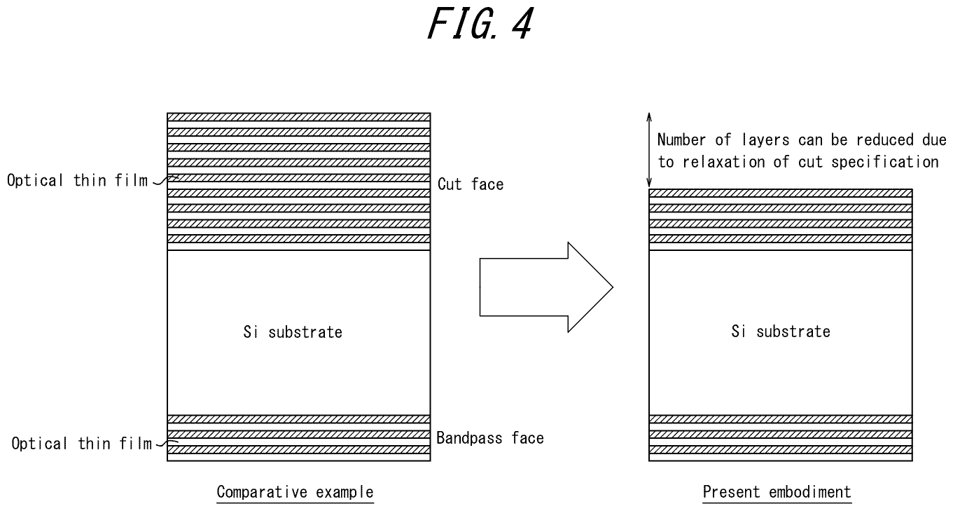

FIG. 4 is a diagram illustrating a difference between an optical filter according to a comparative example and the optical filter according to the present disclosure. In the optical filter of the optical device according to the present embodiment, film thickness of the portion of the multilayer film referred to as the cut face, which determines the property of cutting light, can be significantly decreased. For example, when the multilayer film is formed on both sides of the substrate, the ratio to the total film thickness on each side can be in the range of 0.5 to 2.0.

Details of components of the optical device according to the present embodiment are described below. Here, the optical device includes the infrared light-receiving element or the infrared light-emitting element, and the light-receiving sensitivity of the infrared light-receiving element and the light-emitting intensity of the infrared light-emitting element are both described as “sensitivity”. That is, sensitivity can be read as light-receiving sensitivity when the optical device is configured with the infrared light-receiving element, and as light-emitting intensity when the optical device is configured with the infrared light-emitting element.

### (Optical Filter)

As described above, the optical filter includes the substrate and the multilayer film formed on the substrate and including multiple layers having different refractive indices. The multilayer film may be formed on only one side of the substrate or may be formed on both sides. The optical filter is disposed in the concentration measuring device, on the optical path of infrared light between emission from the infrared light-emitting element and arrival at the infrared light-receiving element. The optical filter may be integrally formed with the infrared light-emitting element or integrally formed with the infrared light-receiving element. Further, the optical filter may be disposed at a defined location on the optical path. A plurality of the optical filter may be disposed in the concentration measuring device. The optical filter can be made by forming a first layer and a second layer on the substrate by vapor deposition.

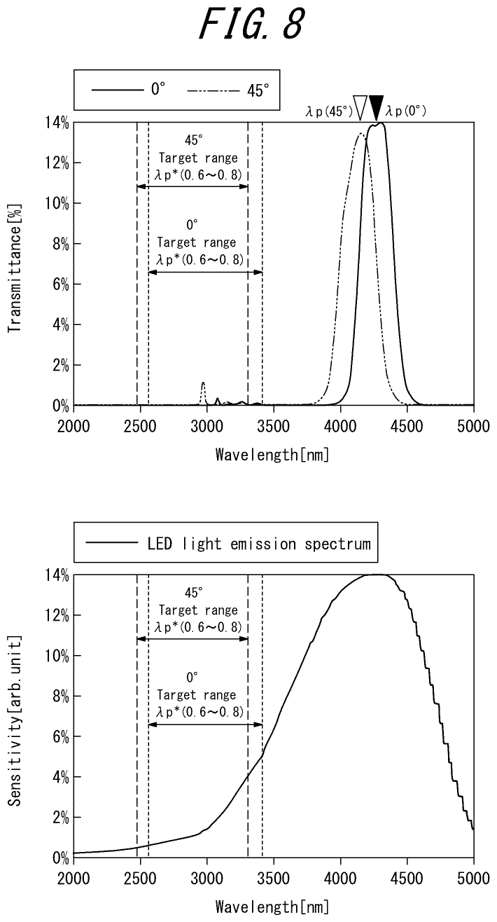

The optical filter according to the present embodiment has, in a wavelength range from 2500 nm to 10,000 nm, a transmission band of 50 nm or more with a transmittance of more than 70%. Further, the optical filter, when the center wavelength of the transmission band is λp, has a maximum transmittance in a wavelength range from (λp×0.6) nm to (λp×0.8) nm of 2% or more. Further, the maximum transmittance is at least twice as large as a minimum transmittance in a wavelength range from (λp×0.8) nm to (λp×0.9) nm. Here, in the wavelength range from (λp×0.6) nm to (λp×0.8) nm, when the angle of incidence of infrared light emitted from or incident on the infrared optical element and incident on the optical filter is 0°, the maximum transmittance of the optical filter in the wavelength range from (λp×0.6) nm to (λp×0.8) nm is T1. Further, in the wavelength range from (λp×0.6) nm to (λp×0.8) nm, when the angle of incidence of infrared light emitted from or incident on the infrared optical element and incident on the optical filter is 45°, the maximum transmittance of the optical filter in the wavelength range from (λp×0.6) nm to (λp×0.8) nm is T2. T2 is greater than T1 (see FIG. 8). Here, the wavelength range from (λp×0.6) nm to (λp×0.8) nm (target range) is denoted as λp*(0.6˜0.8) in FIG. 8. It is generally known that the transmission spectrum of optical filters using multilayer films varies with the angle of incidence. Therefore, when the angle of incidence is 0° and when the angle of incidence is 45°, the value of λp can be different.

Here, transmittance varies depending on measurement conditions. Specifically, transmittance varies with temperature and the angle of incidence of light. Unless otherwise stated, the temperature is assumed to be 25° C. for measurement of transmittance. Further, the angle of incidence of light can be, for example, 0°, 10°, 20°, 30°, 40°, 45°, etc., depending on the design of the concentration measuring device or the like. Unless otherwise stated, the properties described above are satisfied at any angle of incidence. For example, it suffices that the optical filter satisfies the properties described above for at least one of the angles of incidence that can be set in terms of design (30° as an example). Here, the optical filter more preferably satisfies the properties described above at all angles of incidence that can be set in terms of design.

The optical filter is preferably configured so that transmittance at λp, the center wavelength of the transmission band, is at least 1.1 times the maximum transmittance in the wavelength range from (λp×0.6) nm to (λp×0.8) nm. Higher transmittance in the transmission band can improve the performance of the optical device.

The optical filter preferably has a maximum transmittance in the wavelength range of (λp×0.4) nm to (λp×0.6) nm of 2% or more, and more preferably 25% or more. By meeting this requirement, the film thickness of the optical filter can be further decreased. Further, the number of times the first layer and the second layer are stacked can also be decreased.

The optical filter preferably has a maximum transmittance of 60% or less and an average transmittance of 40% or less in the wavelength range from (λp×0.6) nm to (λp×0.8) nm. By meeting this requirement, the film thickness of the optical filter can be decreased while maintaining the performance of the optical device.

The optical filter is preferably a bandpass filter with a full width at half maximum of 1000 nm or less.

### (Substrate)

Any substrate may be used as long as the substrate is suitable for forming each layer of the multilayer film. Examples include, but are not limited to, a GaAs substrate, a Si substrate, a Ge substrate, a ZnS substrate, a sapphire substrate, and the like.

### (Multilayer Film)

The multilayer film is a film including a plurality of layers having different refractive indices. According to the present embodiment, the multilayer film includes a structure of alternating layers of the first layer that has a refractive index in the wavelength range from 6 μm to 10 μm from 1.2 to 2.5 and the second layer that has a refractive index in the wavelength range from 6 μm to 10 μm from 3.2 to 4.3. The first layer comprises the low refractive index material (L) described above. The second layer comprises the high refractive index material (H) described above.

### (First Layer)

Examples of specific materials of the first layer include TiO₂, ZnS, SiO, SiO₂, and the like.

### (Second Layer)

Examples of specific materials of the second layer include Si, Ge, and the like.

### (Method of Measuring Refractive Indices)

The refractive indices of the first layer and the second layer can be measured by an ellipsometer in accordance with “JIS K7142”.

Here, the sensitivity range of the infrared optical element is affected by density of states and Boltzmann distribution. As explained with reference to FIG. 3, by optimally designing the band gap energy, for example, an infrared optical element having high sensitivity in the specific absorption wavelength range corresponding to the gas to be detected and low sensitivity in other wavelength ranges can be realized. As a result, for example, the cutting of 2500 nm to 3500 nm (corresponding to λp×0.6˜0.8 when λp is 4280 nm) becomes unimportant, and the optical filter design can be simplified to reduce costs and improve mass productivity.

### (Method of Measuring Average Transmittance of Optical Filter)

The average transmittance of the optical filter is calculated by dividing the numerical integral of the transmittance in the wavelength range of interest by the wavelength range. The numerical integral of transmittance is obtained by acquiring transmission spectra with an FT-IR microscope (Bruker Corporation, Hyperion 3000+TENSOR 27) in a wavenumber range from 500 cm⁻¹ to 4200 cm⁻¹ and a wavenumber resolution of 8 cm⁻¹, for example. The number of measurement points is 200 points per 1000 nm (=1 point per 5 nm).

Here, the material and thickness of each of the plurality of the first layer may be the same or different. Further, the material and thickness of each of the plurality of the second layer may be the same or different. The multilayer film may further contain layers different from the first layer and the second layer.

The total film thickness of the multilayer film is the sum of the cut face and the bandpass face. A decrease in total film thickness decreases production time and improves yield in optical filter production. Film thickness can be measured by cross-section SEM observation. The total film thickness is preferably 30 μm or less, more preferably 14 μm or less, and even more preferably 10 μm or less. Further, to secure filter performance of the optical filter, the total film thickness is preferably 3 μm or more, and more preferably 8 μm or more.

### (Infrared Optical Element)

The infrared optical element emits or receives infrared light and may include the first conductivity-type semiconductor layer, the active layer, and the second conductivity-type semiconductor layer, as described above. The infrared optical element may specifically be an infrared light-emitting diode (LED) or an infrared photodiode (PD). However, the infrared optical element is not limited to these examples and may be an incandescent light bulb, a laser, an organic light emitting section, a PCSEL, a MEMS heater, a vertical cavity surface emitting LASER (VCSEL), or the like. The infrared optical element may be a phototransistor, a thermopile, a pyroelectric sensor, a bolometer, or the like.

The active layer is a light-absorbing layer or a light-emitting layer (see FIG. 5). According to the present embodiment, the active layer comprises Al_{y}In_{1-y}Sb (0.04≤y≤0.14) or InAs_{y}Sb_{1-y} (0.1≤y≤0.2). Here, “Al_{y}In_{1-y}Sb (0.04≤y≤0.14)” means that Al, In, and Sb are contained in the layer, but other elements may also be included in this expression. Specifically, this expression also includes cases where minor changes are made to the composition of this layer, such as adding small amounts of other elements (for example, As, P, Ga, N, or the like in amounts of a few percent or less). This is also true for other composition expressions.

Here, the Al composition or As composition can be determined, for example, by secondary ion mass spectrometry (SIMS). For example, an IMS 7f magnetic field SIMS system produced by CAMECA may be used for the measurement.

The second conductivity-type is different from the first conductivity-type. The first conductivity-type and the second conductivity-type may respectively be n-type (including n-type impurity), i-type (without impurity), or p-type (including p-type impurity). The first conductivity-type semiconductor layer comprises, for example, n-type InSb (see FIG. 5). Further, the second conductivity-type semiconductor layer comprises, for example, p-type InSb (see FIG. 5). According to the present embodiment, the first conductivity-type is n-type and the second conductivity-type is p-type.

The first conductivity-type semiconductor layer, the active layer, and the second conductivity-type semiconductor layer may be formed on a semiconductor substrate such as a GaAs substrate, a Si substrate, or the like. According to the present embodiment, the infrared optical element includes, in order from the substrate, the first conductivity-type semiconductor layer, the active layer, and the second conductivity-type semiconductor layer. As another example, the infrared optical element may include, in order from the substrate, the second conductivity-type semiconductor layer, the active layer, and the first conductivity-type semiconductor layer.

One or more barrier layers may be provided between the first conductivity-type semiconductor layer and the active layer. Further, one or more barrier layers may be provided between the active layer and the second conductivity-type semiconductor layer. According to the present embodiment, an n-type barrier layer is provided between the first conductivity-type semiconductor layer and the active layer, and a p-type barrier layer is provided between the active layer and the second conductivity-type semiconductor layer. The n-type barrier layer comprises, for example, n-type AlₓIn₁₋ₓSb (0.15≤x≤0.35) (see FIG. 5). The p-type barrier layer comprises p-type Al_{z}In_{1-z}Sb (0.15≤z≤0.35) (see FIG. 5).

According to the present embodiment, the infrared optical element has a peak sensitivity that is the maximum sensitivity, and an average sensitivity in the wavelength range from (λp×0.6) nm to (λp×0.8) nm that is 70% or less of the peak sensitivity. The optical device including the infrared optical element and the simplified optical filter described above can selectively receive or emit infrared light in only the desired wavelength band, enabling compact and high precision concentration measurement. Here, the infrared optical element preferably has an average sensitivity in the wavelength range from (λp×0.6) nm to (λp×0.8) nm that is 30% or less of the peak sensitivity. Here, in the wavelength range from (λp×0.6) nm to (λp×0.8) nm, when the angle of incidence of infrared light emitted from or incident on the infrared optical element and incident on the optical filter is 0°, the average sensitivity of the infrared optical element is S1. Further, in the wavelength range from (λp×0.6) nm to (λp×0.8) nm, when the angle of incidence of infrared light emitted from or incident on the infrared optical element and incident on the optical filter is 45°, the average sensitivity of the infrared optical element is S2. S2 is preferably smaller than S1 (see FIG. 8).

### EXAMPLES

Advantageous effects of the present disclosure are described in detail below based on examples, although the present disclosure is not limited to these examples.

As listed in Table 1, Examples 1 to 6 and Comparative Examples 1 to 3 were evaluated. Examples 1 to 6 were optical devices of the present embodiment having properties as defined in Table 1. Comparative Examples 1 to 3 were single filters that were not simplified. The active layers of the optical devices of Examples 1 to 4 and 6 comprised Al_{y}In_{1-y}Sb, where y was 0.048 for Example 1, y was 0.057 for Example 2, y was 0.089 for Example 3, y was 0.089 for Example 4, and y was 0.057 for Example 6. The active layer of the optical device of Example 5 comprised InAs_{y}Sb_{1-y}, where y was 0.13.

TABLE 1

| | | | Example 1 | | Example 2 | | Example 3 | |
|---|---|---|---|---|---|---|---|---|
| Angle of incidence of light | | | 0° | 45° | 0° | 45° | 0° | 45° |
| Optical | Substrate | Material | Si | | Si | | Si | |
| filter | Multilayer | Material of first layer | SiO | | SiO | | SiO | |
| | film | Material of second layer | Ge | | Ge | | Ge | |
| | | Total film thickness [μm] | 13.8 | | 11.7 | | 9.0 | |
| | Properties | λp [nm] | 4270 | 4130 | 4270 | 4130 | 3390 | 3280 |
| | | (a) Maximum | 0.82% | 11.99% | 3.09% | 8.50% | 2.79% | 3.51% |
| | | transmittance (0° is | | | | | | |
| | | T1, 45° is T2) (λp × | | | | | | |
| | | 0.6)~(λp × 0.8) | | | | | | |
| | | (b) Minimum | 0.00% | 0.00% | 0.02% | 0.07% | 0.01% | 0.05% |
| | | transmittance (λp × | | | | | | |
| | | 0.8)~(λp × 0.9) | | | | | | |
| | | (c) Transmittance at λp | 97.56% | 93.85% | 98.70% | 94.56% | 98.31% | 95.86% |
| | | (d) Maximum | 2.42% | 1.40% | 0.08% | 0.06% | 0.03% | 0.00% |
| | | transmittance (λp × | | | | | | |
| | | 0.4)~(λp × 0.6) | | | | | | |
| | | (e) Average | 0.10% | 0.40% | 0.24% | 0.53% | 0.25% | 0.47% |
| | | transmittance (λp × | | | | | | |
| | | 0.6)~(λp × 0.8) | | | | | | |
| | | (f) Full width at half | 260 | 280 | 260 | 280 | 260 | 280 |
| | | maximum [nm] | | | | | | |
| | | Is (a) at least 2%? | No | Yes | Yes | Yes | Yes | Yes |
| | | Ratio (a)/(b) | 773 | 2726 | 172 | 129 | 193 | 70 |
| | | Ratio (c)/(a) | 119.7 | 7.8 | 32.0 | 11.1 | 35.3 | 27.3 |
| Infrared | Optical | Peak sensitivity | 1 | 1 | 1 | 1 | 1 | 1 |
| optical | properties | (normalized to 1) | | | | | | |
| element | | Average sensitivity | 69.0% | 64.2% | 14.6% | 11.0% | 47.9% | 41.1% |
| | | (0° is S1, 45° is | | | | | | |
| | | S2) (λp × 0.6)~ | | | | | | |
| | | (λp × 0.8) | | | | | | |
| | | Element type | Light- | | Light- | | Light- | |
| | | | receiving | | emitting | | receiving | |
| | | | element | | element | | element | |
| | | | Example 4 | | Example 5 | | Example 6 | |
| Angle of incidence of light | | | 0° | 45° | 0° | 45° | 0° | 45° |
| Optical | Substrate | Material | Si | | Si | | Si | |
| filter | Multilayer | Material of first layer | SiO | | SiO | | SiO | |
| | film | Material of second layer | Ge | | Ge | | Ge | |
| | | Total film thickness [μm] | 8.9 | | 22.4 | | 9.6 | |
| | Properties | λp [nm] | 3400 | 3280 | 8520 | 8280 | 4270 | 4110 |
| | | (a) Maximum | 5.35% | 7.18% | 3.44% | 7.62% | 6.67% | 10.73% |
| | | transmittance (0° is | | | | | | |
| | | T1, 45° is T2) (λp × | | | | | | |
| | | 0.6)~(λp × 0.8) | | | | | | |
| | | (b) Minimum | 0.04% | 0.11% | 0.31% | 0.65% | 0.00% | 0.01% |
| | | transmittance (λp × | | | | | | |
| | | 0.8)~(λp × 0.9) | | | | | | |
| | | (c) Transmittance at λp | 94.99% | 93.06% | 88.99% | 73.42% | 97.99% | 84.16% |
| | | (d) Maximum | 0.01% | 0.00% | 16.90% | 13.44% | 38.17% | 21.53% |
| | | transmittance (λp × | | | | | | |
| | | 0.4)~(λp × 0.6) | | | | | | |
| | | (e) Average | 0.51% | 0.98% | 0.92% | 1.38% | 1.07% | 1.19% |
| | | transmittance (λp × | | | | | | |
| | | 0.6)~(λp × 0.8) | | | | | | |
| | | (f) Full width at half | 270 | 280 | 680 | 620 | 250 | 260 |
| | | maximum [nm] | | | | | | |
| | | Is (a) at least 2%? | Yes | Yes | Yes | Yes | Yes | Yes |
| | | Ratio (a)/(b) | 134 | 63 | 11 | 12 | 2217 | 1119 |
| | | Ratio (c)/(a) | 17.8 | 13.0 | 25.9 | 9.6 | 14.7 | 7.8 |
| Infrared | Optical | Peak sensitivity | 1 | 1 | 1 | 1 | 1 | 1 |
| optical | properties | (normalized to 1) | | | | | | |
| element | | Average sensitivity | 4.7% | 4.0% | 60.4% | 56.2% | 14.6% | 10.5% |
| | | (0° is S1, 45° is | | | | | | |
| | | S2) (λp × 0.6)~ | | | | | | |
| | | (λp × 0.8) | | | | | | |
| | | Element type | Light- | | Light- | | Light- | |
| | | | emitting | | emitting | | emitting | |
| | | | element | | element | | element | |
| | | | Comparative | | Comparative | | Comparative | |
| | | | Example 1 | | Example 2 | | Example 3 | |
| Angle of incidence of light | | | 0° | 45° | 0° | 45° | 0° | 45° |
| Optical | Substrate | Material | Si | | Si | | Si | |
| filter | Multilayer | Material of first layer | SiO | | SiO | | SiO | |
| | film | Material of second layer | Ge | | Ge | | Ge | |
| | | Total film thickness [μm] | 17.1 | | 14.5 | | 33.9 | |
| | Properties | λp [nm] | 4270 | 4130 | 3400 | 3290 | 8500 | 8240 |
| | | (a) Maximum | 0.28% | 0.84% | 0.31% | 0.18% | 1.46% | 1.32% |
| | | transmittance (0° is | | | | | | |
| | | T1, 45° is T2) (λp × | | | | | | |
| | | 0.6)~(λp × 0.8) | | | | | | |
| | | (b) Minimum | 0.00% | 0.00% | 0.00% | 0.00% | 0.03% | 0.10% |
| | | transmittance (λp × | | | | | | |
| | | 0.8)~(λp × 0.9) | | | | | | |
| | | (c) Transmittance at λp | 98.10% | 95.13% | 96.38% | 91.53% | 84.97% | 69.50% |
| | | (d) Maximum | 0.03% | 0.03% | 0.00% | 0.00% | 1.46% | 4.58% |
| | | transmittance (λp × | | | | | | |
| | | 0.4)~(λp × 0.6) | | | | | | |
| | | (e) Average | 0.01% | 0.04% | 0.02% | 0.03% | 0.22% | 0.33% |
| | | transmittance (λp × | | | | | | |
| | | 0.6)~(λp × 0.8) | | | | | | |
| | | (f) Full width at half | 260 | 270 | 270 | 270 | 640 | 560 |
| | | maximum [nm] | | | | | | |
| | | Is (a) at least 2%? | No | No | No | No | No | No |
| | | Ratio (a)/(b) | 493 | 232 | 514 | 107 | 43 | 13 |
| | | Ratio (c)/(a) | 350.4 | 113.1 | 310.4 | 498.6 | 58.3 | 52.7 |

| | | | | | |
|---|---|---|---|---|---|
| Infrared | Optical | Peak sensitivity | — | — | — |
| optical | properties | (normalized to 1) | | | |
| element | | Average sensitivity | — | — | — |
| | | (0° is S1, 45° is | | | |

S2) (λp × 0.6)~
(λp × 0.8)

| | | | |
|---|---|---|---|
| Element type | — | — | — |

The PIN diode structures of the infrared optical elements of Examples 1 to 6 were created by the MBE method. FIG. 5 illustrates the stack structure of layers of the infrared optical elements of Examples 1 to 6. Barrier layers of n-type and p-type were provided sandwiching the active layers. Positive photoresist for i-line was coated on the surface of a semiconductor wafer, and exposure was carried out using the i-line with a reduction projection-type exposure machine. Subsequently, development was performed, and a plurality of resist patterns were regularly formed on the surface of the semiconductor stacked portion. Subsequently, a plurality of mesas were formed by dry etching. After forming a SiO₂ film as a hard mask on the element having a mesa shape, elements were isolated by dry etching, a SiN film was formed as a protective film, and contact holes were formed by photolithography and dry etching. Subsequently, a plurality of mesas were connected in series by photolithography and sputtering, and the element surface was covered with a protective film of polyimide resin. The wafer prepared as described above was diced into individual pieces, bonded with Au wires and wired to a lead frame, and encapsulated with epoxy molding resin so that the light-receiving surface was exposed. The infrared light-receiving element prepared in this way had sensitivity to infrared light around λp, but the sensitivity was 70% or less of the peak sensitivity in the wavelength range from (λp×0.6) nm to (λp×0.8) nm.

The optical filter design was carried out using simulation. The optical filters of Examples 1 to 6 were simplified optical filters, all of which had, in the wavelength range from 2500 nm to 10,000 nm, a transmission band of 50 nm or more with a transmittance of more than 70%. As listed in Table 1, the ratio (a)/(b) was 2 or more for the optical filters of Examples 1 to 6. Here, (a) is the maximum transmittance in the wavelength range from (λp×0.6) nm to (λp×0.8) nm. Of the values indicated as (a), 0° is T1 and 45° is T2. For the optical filters of Examples 1 to 6, (a) was 2% or more and T2 was greater than T1. Further, (b) is the minimum transmittance in the wavelength range from (λp×0.8) nm to (λp×0.9) nm. Further, the infrared optical elements of Examples 1 to 6 had an average sensitivity in the wavelength range from (λp×0.6) nm to (λp×0.8) nm that was 70% or less of the peak sensitivity. Further, the infrared optical elements of Examples 1 to 6 had a smaller average sensitivity S2 at 45° incidence than S1 at 0° incidence in the average sensitivity in the wavelength range from (λp×0.6) nm to (λp×0.8) nm.

As listed in Table 1, the ratio (c)/(a) was 1.1 or more for the optical filters of Examples 1 to 6. Here, (c) is the transmittance at λp. Further, the optical filters of Examples 1, 5, and 6 had a maximum transmittance of 2% or more in the wavelength range from (λp×0.4) nm to (λp×0.6) nm. Here, as mentioned above, the angle of incidence of light can vary depending on the design of the concentration measuring device and other factors, but it is sufficient if the property is satisfied for at least one angle of incidence. For Example 1, the maximum transmittance in the wavelength range from (λp×0.4) nm to (λp×0.6) nm was 2% or more at least for an angle of incidence of 0°. The same determination was made as to whether (a) described above was 2% or more. Further, the optical filters of Examples 1 to 6 had a maximum transmittance of 60% or less and an average transmittance of 40% or less in the wavelength range from (λp×0.6) nm to (λp×0.8) nm. Further, the optical filters of Examples 1 to 6 were bandpass filters having a full width at half maximum of 1000 nm or less.

In contrast, for Comparative Examples 1 to 3, (a) was less than 2%.

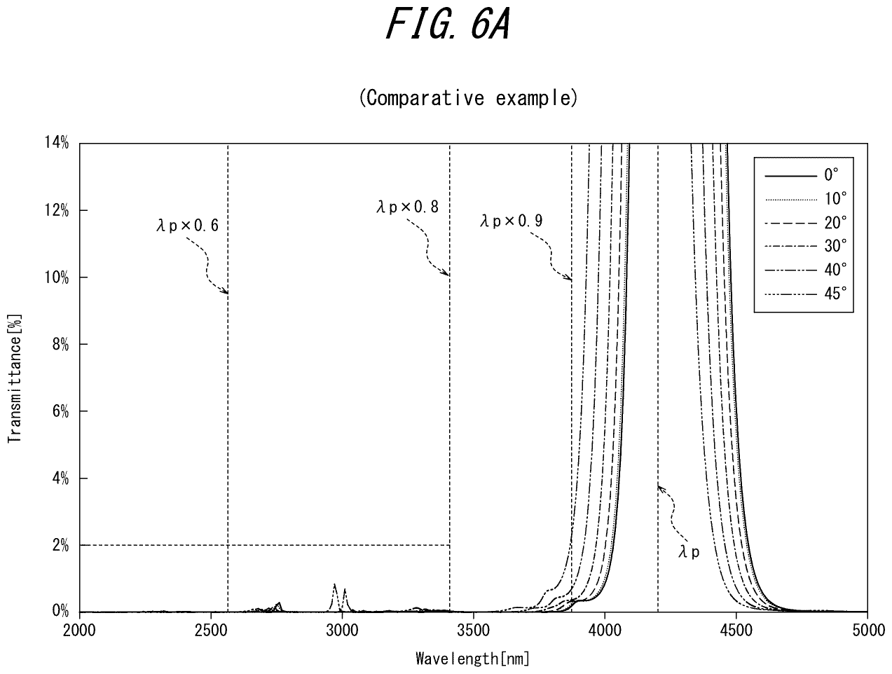

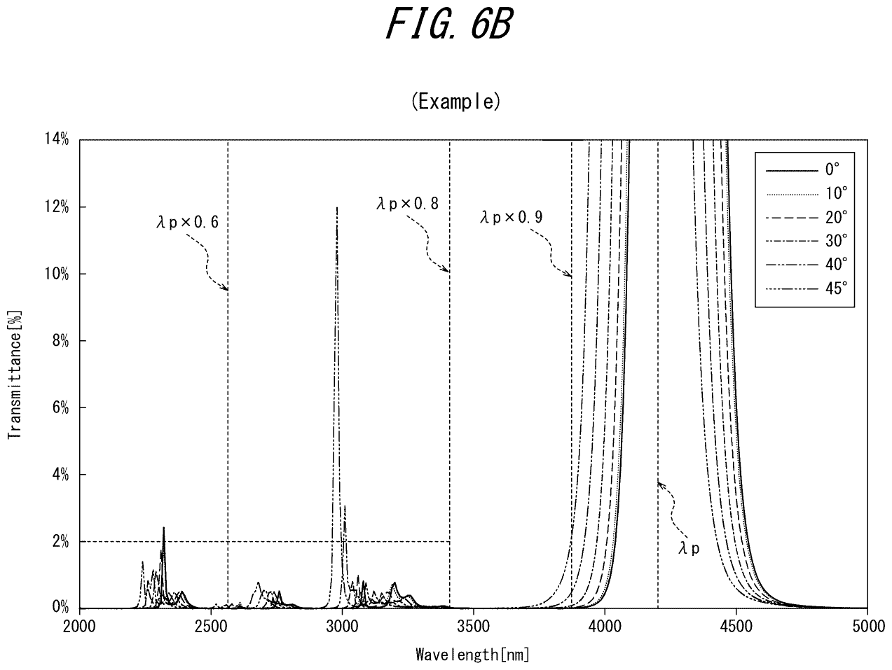

FIG. 6A and FIG. 6B are diagrams comparing the transmittance of an Example (FIG. 6B) and a Comparative Example (FIG. 6A). The vertical axis is the transmittance and the horizontal axis is the wavelength of infrared light. The graph for Example 1 is used as a representative example, but similar trends were obtained for Examples 1 to 6. Further, the graph for Comparative Example 1 is used as a representative example, but similar trends were obtained for Comparative Examples 1 to 3. Further, the graphs indicate transmittance superimposed for several angles of incidence (0°, 10°, 20°, 30°, 40°, and 45°). As illustrated in FIG. 6B, the graph of the Example indicates that the maximum transmittance in the wavelength range from (λp×0.6) nm to (λp×0.8) nm exceeded 2%, meaning the property of cutting light was relaxed in this wavelength range.

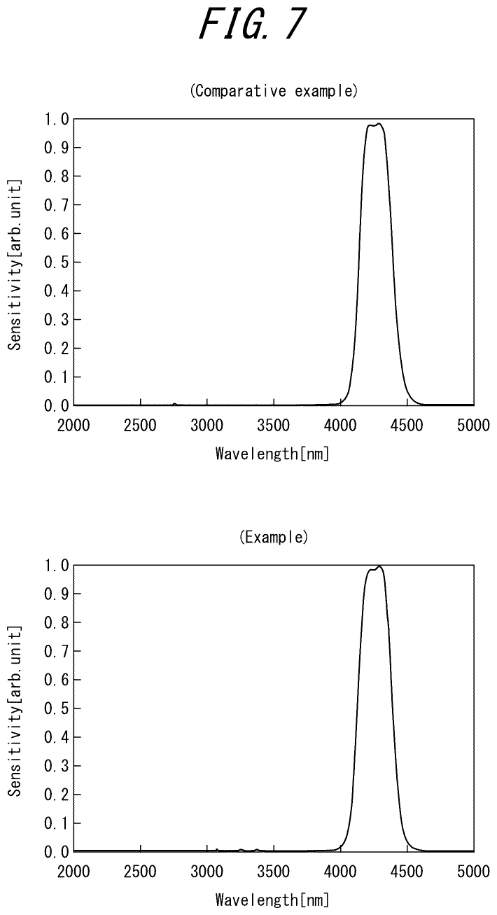

FIG. 7 is a diagram comparing sensitivity of an Example and a Comparative Example. The vertical axis is the sensitivity and the horizontal axis is the wavelength of infrared light. The graph for Example 1 is used as a representative example, but similar trends were obtained for Examples 1 to 6. Further, the graph for Comparative Example 1 (combined with an infrared optical element) is used as a representative example, but similar trends were obtained for Comparative Examples 1 to 3. When a concentration measuring device is configured using an optical device (see FIG. 2), the optical device according to the present embodiment achieves equivalent performance to a Comparative Example using an optical filter that is not simplified, as illustrated in FIG. 7. That is, it was confirmed that the precision of the optical device according to the present embodiment does not degrade even when a simplified optical filter is used. Here, for the Comparative Example, the optical filter of the Comparative Example was combined with an infrared optical element to form an optical device, and then the optical device was used to configure a concentration measuring device.

As described above, the optical device according to the present embodiment is made compact by simplification of the optical filter, while also being capable of receiving/emitting light of a desired wavelength, and is usable in a gas concentration measuring device or the like to enable high precision concentration measurement. The optical filter according to the present embodiment is usable in an optical device that enables high precision concentration measurement.

Although embodiments of the present disclosure have been described based on the drawings and examples, it should be noted that a person skilled in the art may make variations and modifications based on the present disclosure. Therefore, it should be noted that such variations and modifications are included within the scope of the present disclosure.

1. An optical device comprising:
an optical filter including a substrate and a multilayer film formed on at least one surface of the substrate, the multilayer film including a plurality of layers having different refractive indices; and
an infrared optical element that emits or receives infrared light, wherein
the optical filter has, in a wavelength range from 2500 nm to 10,000 nm, a transmission band of 50 nm or more with a transmittance of more than 70%, wherein the center wavelength of the transmission band is λp, a maximum transmittance in a wavelength range from (λp×0.6) nm to (λp×0.8) nm is 2% or more, and the maximum transmittance is at least twice as large as a minimum transmittance in a wavelength range from (λp×0.8) nm to (λp×0.9) nm,
the infrared optical element has a peak sensitivity that is a maximum sensitivity, and an average sensitivity in the wavelength range from (λp×0.6) nm to (λp×0.8) nm is 70% or less of the peak sensitivity, and
in the wavelength range from (λp×0.6) nm to (λp×0.8) nm, when the angle of incidence at which infrared light emitted from or incident on the infrared optical element is incident on the optical filter is 0°, the maximum transmittance of the optical filter is T1 and the average sensitivity of the infrared optical element is S1, and when the angle of incidence at which infrared light emitted from or incident on the infrared optical element is incident on the optical filter is 45°, the maximum transmittance of the optical filter is T2 and the average sensitivity of the infrared optical element is S2, then T2 is greater than T1 and S2 is smaller than S1.

2. The optical device according to claim 1, wherein the transmittance of the optical filter at λp, the center wavelength of the transmission band, is at least 1.1 times the maximum transmittance in the wavelength range from (λp×0.6) nm to (λp×0.8) nm.

3. The optical device according to claim 1, wherein the optical filter has a maximum transmittance of 2% or more in a wavelength range from (λp×0.4) nm to (λp×0.6) nm.

4. The optical device according to claim 1, wherein the optical filter has a maximum transmittance of 60% or less and an average transmittance of 40% or less in the wavelength range from (λp×0.6) nm to (λp×0.8) nm.

5. The optical device according to claim 1, wherein the optical filter is a bandpass filter with a full width at half maximum of 1000 nm or less.

6. The optical device according to claim 1, wherein the infrared optical element is an infrared light-emitting element that emits infrared light, and the average sensitivity in the wavelength range from (λp×0.6) nm to (λp×0.8) nm is 30% or less of the peak sensitivity.

7. The optical device according to claim 1, wherein the total film thickness of the multilayer film is 30 μm or less.

8. An optical device comprising:
an optical filter including a substrate and a multilayer film formed on at least one surface of the substrate, the multilayer film including a plurality of layers having different refractive indices; and
an infrared optical element that emits or receives infrared light, wherein
the optical filter has, in a wavelength range from 2500 nm to 10,000 nm, a transmission band of 50 nm or more with a transmittance of more than 70%, wherein the center wavelength of the transmission band is λp, a maximum transmittance in a wavelength range from (λp×0.6) nm to (λp×0.8) nm is at least twice as large as a minimum transmittance in a wavelength range from (λp×0.8) nm to (λp×0.9) nm, and a maximum transmittance in a wavelength range from (λp×0.4) nm to (λp×0.6) nm is 2% or more,
the infrared optical element has a peak sensitivity that is a maximum sensitivity, and an average sensitivity in the wavelength range from (λp×0.6) nm to (λp×0.8) nm is 70% or less of the peak sensitivity, and
in the wavelength range from (λp×0.6) nm to (λp×0.8) nm, when the angle of incidence at which infrared light emitted from or incident on the infrared optical element is incident on the optical filter is 0°, the maximum transmittance of the optical filter is T1 and the average sensitivity of the infrared optical element is S1, and when the angle of incidence at which infrared light emitted from or incident on the infrared optical element is incident on the optical filter is 45°, the maximum transmittance of the optical filter is T2 and the average sensitivity of the infrared optical element is S2, then T2 is greater than T1 and S2 is smaller than S1.

9. The optical device according to claim 1, wherein the infrared optical element includes a first conductivity-type semiconductor layer, an active layer, and a second conductivity-type semiconductor layer.

10. The optical device according to claim 1, wherein the infrared optical element is an infrared light-emitting element.

11. The optical device according to claim 1, wherein T2 is at least 1% greater than T1.

12. The optical device according to claim 8, wherein the maximum transmittance in the wavelength range from (λp×0.4) nm to (λp×0.6) nm is 25% or more.

13. An optical filter, used in the optical device according to claim 1.

14. An optical filter, used in the optical device according to claim 8.

15. The optical device according to claim 8, wherein the transmittance of the optical filter at λp, the center wavelength of the transmission band, is at least 1.1 times the maximum transmittance in the wavelength range from (λp×0.6) nm to (λp×0.8) nm.

16. The optical device according to claim 8, wherein the optical filter has a maximum transmittance of 60% or less and an average transmittance of 40% or less in the wavelength range from (λp×0.6) nm to (λp×0.8) nm.

17. The optical device according to claim 8, wherein the infrared optical element is an infrared light-emitting element that emits infrared light, and the average sensitivity in the wavelength range from (λp×0.6) nm to (λp×0.8) nm is 30% or less of the peak sensitivity.

18. The optical device according to claim 8, wherein the infrared optical element includes a first conductivity-type semiconductor layer, an active layer, and a second conductivity-type semiconductor layer.

19. The optical device according to claim 8, wherein the infrared optical element is an infrared light-emitting element.

20. The optical device according to claim 8, wherein T2 is at least 1% greater than T1.
